(19) United States
(12) Patent Application Publication
(10) Pub. No.: US 2020/0044953 A1
(43) Pub. Date: Feb. 6, 2020

(54) Data Packet Fast Routing Method

(71) Applicant: Shi Jin Chen, Alpharetta, GA (US)

(72) Inventor: Shi Jin Chen, Alpharetta, GA (US)

(21) Appl. No.: 16/053,776

(22) Filed: Aug. 2, 2018

(51) Int. Cl. H04L 12/751

(52) U.S. Cl. CPC H04L 45/02; H04L 45/66

(57) ABSTRACT

Data packet routing are based on layer 2 or layer 3 address such as Ethernet address and IP address. For Ethernet layer 2 switch, an Ethernet mac address table indicates the destination MAC address goes to which physical port after learning: every packet needs to check this table to route packet. For IP routing, MPLS and other protocols are used. All layer 2 and layer 3 data routing requires data address looking and routing table searching: these is the bottle neck of the data routing. Fast routing method: using next hop sequence list to replace layer 2 content or as part of IP layer is the best way: this will not use any routing table because packet itself contains next hop in its next hop list where the next hop list works as a hash table to route the packet through all nodes in the network.

### CROSS REFERENCE TO RELATED APPLICATION

This application is a non-provisional application claiming the benefit of U.S. Provisional Application Ser. No. 62/541,664, entitled “Data Packet Fast Routing Mothed,” which was filed on Aug. 5, 2017, and is incorporated herein by reference in its entirety.

### TECHNICAL FIELD

This disclosure related how to route packet data in network using fast Routing Mothed.

### BACKGROUND

In normal case, all data packet routing are based on layer 2 address or layer 3 address such as Ethernet address and IP address.

For Ethernet layer 2 switch, there is an Ethernet mac address table indicates the destination MAC address goes to which physical port after learning. Every packet need to check this table to know where to send packet.

For IP routing, normally MPLS and other protocol are used to make the routing algorithm as simple and fast as possible. Industry are seeking better algorithm to route data at layer 2 which is the lowest layer that can do routing.

All layer 2 and layer 3 data routing requires layer 2/layer 3 data looking and routing table searching and these is the bottle neck of the data routing from source to destination. Another rule is: the layer lower where the routing decision is made, the faster the packet is transferred.

This means: layer 2 data switch is much faster than layer 3 data switch and all industry are seeking better algorithm to route data at layer 2 which is the lowest layer that can do routing.

For fiber optical communication, data packet routing can be done at physical layer: different application/session/connection between two network nodes using different wavelength light between two network nodes and light resource can be dynamically assigned accordingly.

### BRIEF DESCRIPTION OF DRAWINGS

FIG. 1 is a block diagram illustration an example network environment operable to show the network connection between two devices

FIG. 2 is a block diagram illustration an example network environment operable to build data routing header next hop list

FIG. 3 is a block diagram illustration an example network environment operable to transfer data routing header next hop list

FIG. 4 is a block diagram illustration an example network environment operable to transfer data packet using fast routing mothed

FIG. 5 is a block diagram illustration an example network environment operable to transfer data packet using fast routing mothed

### DETAILED DESCRIPTION

It is desirable to improve method and system to route data packet through the network with less effort. The methods, systems, and computer readable media described herein can be operable to router data packet through network router, switch, gateway, and device between data source and data destination of a data packet. Fast routing method may be used at a network device when it supports this mothed. Fast routing method herein includes the following elements: fast routing header, the way to build fast routing information between any two network devices, and the way to use fast routing header to route a packet through the network.

Fast routing header is a new header that carries a packet routing information that a data packet can be routed through the network. A packet routing information is a next hop list that a data packet will be routed through a network. The first data of a next hop list is used by current routing device to route the data packet to: instead of using any other methods to find a way to route data packet, the current device can use this first or last data of next hop list to route the data packet to the destination. In this way, the routing device can route the data fast with minimum effort.

Fast routing header, using next hop sequence list to replace layer 2 content is the best way: this will not use any routing algorithm because packet itself contains next hop in its next hop list where the next hop list works as a hash table to route the packet at layer 2 through all nodes in the network. This likes next hop in IP layer but we add it here at layer two so packet processing will be much faster. Using this way, each packet included its own routing information inside the packet itself. This new mothed won't change the content of the layer above the layer 2, and it will not change the content of IP layer; it only replace layer 2 and use the current layer 2 space to hold this new header: fast routing header.

When fast routing header is used at layer 2, there is no layer 2 address used in this new data transmission protocol: instead of layer 2 address, the space/location that are used to hold original layer 2 information will be used to hold this new fast routing header, and a group of new identities are defined to indicates the present of this new header. All space that layer 2 layer used in data packet is replaced by this new header: fast routing header.

Fast routing header also can be part of IP layer: a new option IP header can be added in IP layer to carry a fast routing header.

The functions of fast routing header are: when receiving a data packet, if the first header is fast routing header, it can use this header to router the packet without checking rest of packet because the fast routing header includes the next hop list: it tell the node where this packet should be forwarded to. The fast routing header can includes the packet QOS information.

The fast routing header should include following but not limit to: the identity that indicates a fast routing header present in current data packet; the information that indicates the property of packet such as packet; the next hop list that include the next hop list information.

The identity can be for one or more of following purpose: indicates that fast routing header is present in this packet; QOS of the packet: priority, latency; Security of the packet; type of the packet such as unicast/broadcast/multicast; content of data: video/voice/data; size of data packet.

All parameters that are used to route the data packet in layer 2 and layer 3 can be put in the next hop list: each node can decide which parameter is best for the node itself to do data routing with less effort.

The item in next hop list can be following but not limited: Router/Gateway physical port, fiber channel, IP routing table index, MPLS label/index, GMPLS label/index, time slots, wavelengths, RF Frequency, etc.

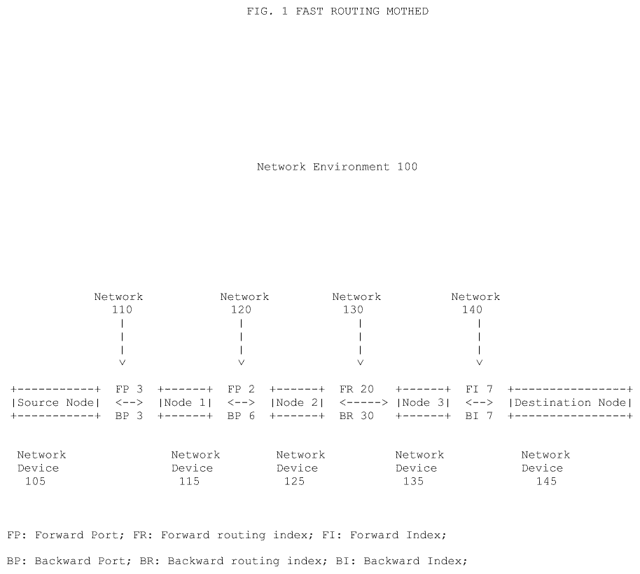

FIG. 1 is a block diagram illustrating an example network environment 100 operable to facilitate the procedure how a fast routing header created/transferred/used. Network device 105 (source node) and network device 145 (destination node) may be a customer premise equipment. Network device 105 and network device 145 may be a multiple systems operator (MSO) devices. Network device 115, 125, and network device 135 may be a multiple systems operator (MSO) devices. Each network device has one or multiple address so device can find each other through its address. The address can be IPv4 address, IPv6 address, or any other address used by current LAN network or WAN network.

Network 110, 120, 130,140 may include an optical network, hybrid fiber coaxial (HFC) network, twisted-pair, wireless network, high-speed data network, and others. Multiple systems operator (MSO) devices and/or networks may be used to provide, manage, and/or troubleshoot the multiple services such as data routing/switching service provided to subscribers.

Network physically is used to connection two network devices as shown in FIG. 1: network device 105 connects directly network device 115 through network 110; network device 115 connects directly network device 125 through network 120; network device 125 connects directly network device 135 through network 130; network device 135 connects directly network device 145 through network 140.

For network device 105, there may be many routing ports can be used to route packet data. Routing port can be logical port or physical port. Different routing port can be used to route packet data to different destination according to network connection and configuration. By using fast routing method as shown in FIG. 1, port index 3 of network device 105 can be used to forward packet data to network device 115 where the final destination is network device 145 where the fast routing method can be used. In this case network 110 is used. Similar, for network device 115, routing port 3 can be used to route packet to network device 105 where original data source from network device 145.

For network device 115, by using fast routing method as shown in FIG. 1, port index 2 of network device 115 can be used to forward packet data to network device 125 where the final destination is network device 145 where the fast routing method can be used. In this case network 120 is used. Similar, for network device 125, routing port 6 can be used to route packet to network device 115 where original data source from network device 145.

For network device 125, there may be many routing index can be used to route packet data. Routing index can be logical and is mapped to a physical port. Different routing index can be used to route packet data to different destination according to network connection and configuration. By using fast routing method as shown in FIG. 1, routing index 20 of network device 125 can be used to forward packet data to network device 135 where the final destination is network device 145 where the fast routing method can be used. In this case network 130 is used. Similar, for network device 135, routing index 30 can be used to route packet to network device 125 where original data source from network device 145.

For network device 135, there may be many switching indexes can be used to route packet data. Switching indexes can be logical port or physical port. Different switching indexes can be used to route packet data to different destination according to network connection and configuration. By using fast routing method as shown in FIG. 1, switching index 7 of network device 135 can be used to forward packet data to network device 145 which is the final destination network device 145 where the fast routing method can be used. In this case network 140 is used. Similar, for network device 145, switching index 7 can be used to route packet to network device 135 where original data source from network device 145.

There are two next hop lists for each session: SD hop list and DS hop list. SD hop list is a next hop list from source node (network device 105) to destination node (network device 145). DS hop list is a next hop list from destination node to source node. The direction of SD hop list and DS hop list is based on the original source where data packet is sent first.

In FIG. 1, for network device 1, FP (Forward Port), FR (Forward routing index, and FI (Forward Index) can be used in SD hop list; BP (Backward Port), BR (Backward routing index) and BI (Backward Index) can be used in DS hop list. For network device 105 (shown in FIG. 1 as Source Node), FP 3 is first hop for data packet to network device 145 (shown in FIG. 1 as Destination Node). For network device 115 (shown in FIG. 1 as Node 1), FP 2 is the first hop for data packet to network device 145; For network device 115, BP 3 is the last DS hop for data packet to network device 105 to network device 145. For network device 125 (shown in FIG. 1 as Node 2), FR 20 is the next hop for data packet to network device 145; For network device 125, BP 6 is a DS hop for data packet to network device 105 to network device 145. For network device 135 (shown in FIG. 1 as Node 3), FI 7 is the last hop for data packet to network device 145; For network device 135, BP 30 is a DS hop for data packet to network device 105 to network device 145. For network device 145, BI 7 is a DS hop for data packet to network device 105 to network device 145.

There are many ways to setup next hop list for the IP network. One way is during session establishment stage, a single SD hop list header added in IP layer: the source node who need to send packet to the destination adds its own next routing hop information in SD hop list header; Each node through the network does the same thing for the same data packet; the ending node has full SD hop list and it will send this hop list back to the source node; the source node gets the SD hop list and add fast routing header in the data packet with same destination; When the replied data packet sent back from the destination node to the source node, all nodes works just like above steps to build DS hop list; When the source node gets the DS hop list, it will send this list to the destination node so both side have its next hop list for this session.

Another way is during session establishment stage, both SD hop list and DS hop list are added in IP layer: the source node adds its own next routing hop information in SD hop list and DS hop list; each node through the network does the same thing for the same packet; the destination node has all full SD hop list and DS hop list; the destination will use DS hop list to transfer data packet to source node and put SD hop list in IP layer as application data; all nodes through the path will use fast routing header to route the data packet to the source node of the session; the source node gets the SD hop list and use this new mothed to transfer the future data packet.

Third way: reusing ICMP protocol or other routing path finding protocol: several new control type messages are added to detect/build the next hop list and exchange next hop information between nodes. During detect/build time, if any network node has cache of next hop list to the destination, it can return the result to source right away. Each network node in the network can do this next hop list maintenance in order to make system data transfer more efficient.

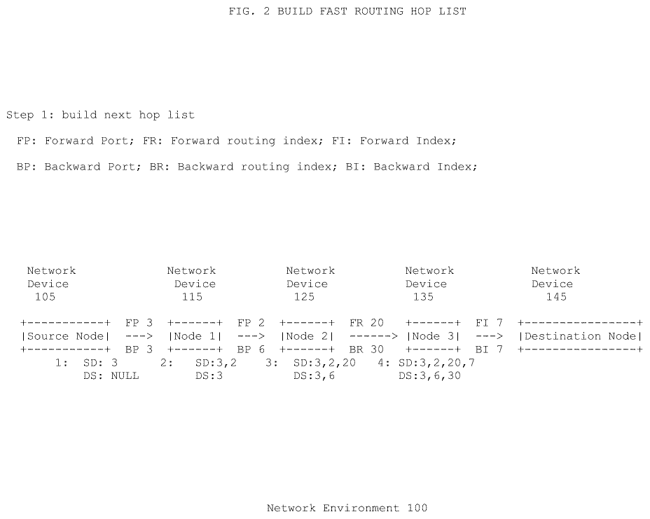

FIG. 2 is a block diagram illustrating an example network environment 100 operable to facilitate the procedure how a fast routing hop list is built. For network device 105, when there is a data packet need to be sent to network device 145, port index 3 of network device 105 can be used to forward the packet data according to its local routing algorithm. If there is no fast routing hop list found for the address of network device 145 in the network device 105, the network device 115 can start to build a fast routing hop list to the address of network device 145. Before sending the data packet out, it adds two new headers into the data packet: SD hop list header and DS hop list header. There is one element in its SD hop list header: 3 which mean that Forward Port index 3 is used to forward this data packet in network device 105. There is nothing in its DS hop list header at this moment. These two headers can be added at IP layer or new application layer.

In FIG. 2, when Network Device 115 (Node 1) receive the data packet and knows there is fast routing hop list inside, it adds FP 2 into the SD hop list and BP 3 into DS hop list. Then it sends the new data packet to the network device 125 (Node 2) through its forward port 2. At this time, there are two elements in SD hop list of the new data packet: first is FP3 and second is FP 2; there is one element in DS hop list: BP 3.

In FIG. 2, when Network Device 125 (Node 2) receive the data packet and knows there is fast routing hop list inside, it adds FR 20 into the SD hop list and BP 6 into DS hop list. Then it sends the new data packet to the network device 135 (Node 3) through its forward routing index 20. At this time, there are three elements in SD hop list of the new data packet: the first is FP3, the second is FP 2, and the third FR 20; there are two elements in DS hop list: the first is BP 3 and the second is BP 6.

In FIG. 2, when Network Device 135 (Node 3) receive the data packet and knows there is fast routing hop list inside, it adds FI 7 into the SD hop list and BR 30 into DS hop list. Then it sends the new data packet to the network device 145 (Destination Node) through its forward index 7. At this time, there are four elements in SD hop list of the new data packet: the first is FP3, the second is FP 2, the third FR 20, and the forth FI 7; there are three elements in DS hop list: the first is BP 3, the second is BP 6, and third is BR 30.

In FIG. 2, when Network Device 145 (Destination Node) receive the data packet and knows there is fast routing hop list inside, it found that itself is the destination of the data packet. At this time, Network Device 145 (Destination Node) has all fast routing hop list for the connection between Network Device 145 (Destination Node) and Network Device 105 (Source Node): full SD hop list are the first is FP3, the second is FP 2, the third FR 20, and the forth FI 7; and full DS hop list: the first is BP 3, the second is BP 6, and third is BR 30, plus BI 7 which is its own routing hop to Source Node. At this point, Network device 145 has next hop lists between Network Device 105 and Network Device 145.

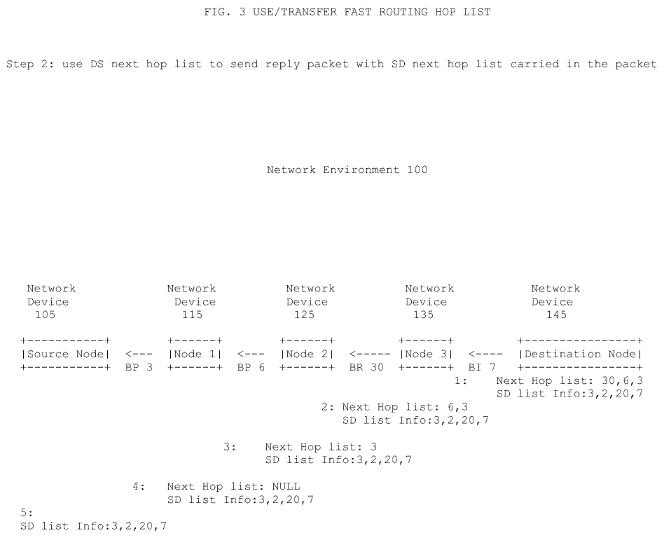

FIG. 3 is a block diagram illustrating an example network environment 100 operable to facilitate the procedure how a fast routing hop list is used and transferred between two Network Devices. Network Device 145 (Destination Node of this session) set DS hop list as the next hop list of the data packet; the SD hop list also be put in the data packet as part of IP layer or application layer; then send the data packet to Network Device 135 through its switch index 7. The content of the SD hop list is kept unchanged as it was received. The next hop list in the fast routing header is the reverse sequence of the DS hop list in this case. The sequence of the data inside all hop lists is just an example. The sequence of hop list can be: the next hop of first node is the first element of list and next hop of last node is the last of list; the next hop of first node is the last element of list and next hop of last node is the first of list.

In FIG. 3, when Network Device 135 receives the data packet and finds that these is fast routing head inside, it will get first next hop and use it to route the data packet after remove the first hop in next hop list. This data packet is sent to Network device 125 through the routing index 30 of Network device 135. When Network Device 135 receives the data packet, there are 3 elements in its next hop list: R 30, P 6 and P 3; when Network Device 135 sends the packet out to Network Device 125 through routing Index 30, there are two elements in the data packet next hop list: P6 and P3. Routing index 30 is used for Network Device 135 to route this packet and it is removed from the next hop list before it is sent out from Network Device 135.

In FIG. 3, when Network Device 125 receives the data packet and finds that these is fast routing head inside, it will get first next hop and use it to route the data packet after remove the first hop in next hop list. This data packet is sent to Network device 115 through the port index 6 of Network device 115. When Network Device 125 receives the data packet, there are 2 elements in its next hop list: P 6 and P 3; when Network Device 125 sends the packet out to Network Device 115 through port Index 6, there is one element in the data packet: P3. Porting index 6 is used for Network Device 125 to route this packet and it is removed from the next hop list before it is sent out from Network Device 115.

In FIG. 3, when Network Device 115 receives the data packet and finds that these is fast routing head inside, it will get first next hop and use it to route the data packet after remove the first hop in next hop list. This data packet is sent to Network device 105 through the port index 3 of Network device 105. When Network Device 115 receives the data packet, there is one element in its next hop list: P 3; when Network Device 115 sends the packet out to Network Device 105 through port Index 3, there is nothing in the data packet next hop list. Porting index 3 is used for Network Device 115 to route this packet and it is removed from the next hop list before it is sent out from Network Device 105. At this time the next hop list of the data packet is empty, Network Device 115 can keep this fast routing header or can remove it from the data packet before send it out to Network Device 105.

In FIG. 3, when Network Device 105 receives the data packet and finds that these is no fast routing head inside or it finds that the data packet next hop list is empty, Network Device 105 knows the fast routing method can't be used for the data packet. After further parsing the data packet, the SD hop list in the data packet information is found: this SD hop list is saved in Network Device 105 and this SD hop list will be used as next hop list to transfer data packet where the destination of the data packet is Network Device 145.

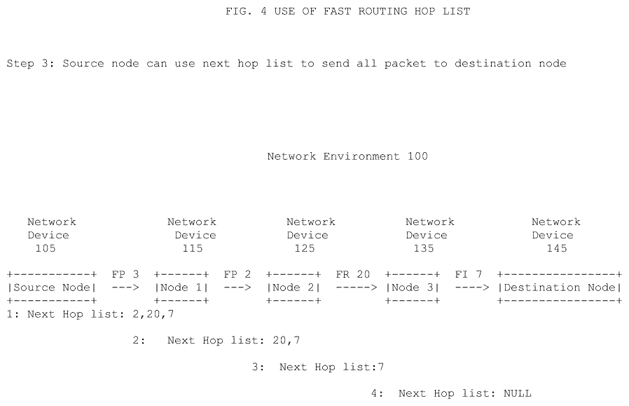

FIG. 4 is a block diagram illustrating an example network environment 100 operable to facilitate the procedure how a fast routing hop list is used between two Network Devices after Network Device 105 gets the next hop list to Network Device 145. At this point, all Network Devices between Network Device 105 (Source Node of this session) and Network Device 145 (Destination Node of this session) have a next hop list to both end nodes.

In FIG. 4, for Network Device 105, when there is any packet needs to be sent to Network Device 145, Network Device 105 sets saved the next hop list into the fast routing header of the data packet: P2, R 20 and I 7; then send the data packet to Network Device 115 through its port index 3.

In FIG. 4, when Network Device 115 receives the data packet and finds that these is fast routing head inside, it will get first next hop and use it to route the data packet after remove the first hop in next hop list. This data packet is sent to Network device 125 through the port index 2 of Network device 115. When Network Device 115 receives the data packet, there are 3 elements in its next hop list: P 2, R 20 and I 7; when Network Device 115 sends the packet out to Network Device 125 through port Index 2, there are two elements in the data packet next hop list: R 20 and I 7. Porting index 2 is used for Network Device 115 to route this packet and it is removed from the next hop list before it is sent out from Network Device 125.

In FIG. 4, when Network Device 125 receives the data packet and finds that these is fast routing head inside, it will get first next hop and use it to route the data packet after remove the first hop in next hop list. This data packet is sent to Network device 135 through the routing index 2 of Network device 125. When Network Device 125 receives the data packet, there are 2 elements in its next hop list: R 20 and I 7; when Network Device 125 sends the packet out to Network Device 135 through routing Index 20, there is one element in the data packet next hop list: I 7. Routing index 20 is used for Network Device 125 to route this packet and it is removed from the next hop list before it is sent out from Network Device 135.

In FIG. 4, when Network Device 135 receives the data packet and finds that these is fast routing head inside, it will get first next hop and use it to route the data packet after remove the first hop in next hop list. This data packet is sent to Network device 145 through the switching index 7 of Network device 135. When Network Device 135 receives the data packet, there is one element in its next hop list: I 7; when Network Device 135 sends the packet out to Network Device 145 through its switching Index 7, there is nothing in the data packet next hop list. Switching index 7 is used for Network Device 135 to route this packet and it is removed from the next hop list before it is sent out from Network Device 145. So the data packet is routed to its destination using fast routing method.

Fast routing method can be used by any two network nodes: when a data packet needs to go through these two nodes, a pre-saved fast routing header can be added into this packet. Operator or network routing detection system can set two nodes as two end nodes of a fast routing method rule: any data packet transferred between one set of address and another set of address can use this fast routing method rule to route the packet.

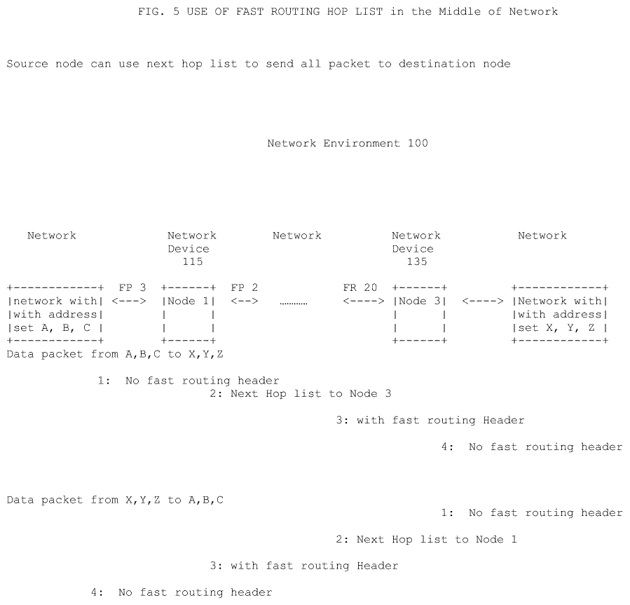

FIG. 5 is a block diagram illustrating an example network environment 100 operable to facilitate the procedure how a fast routing hop list is used between two set of Network Devices.

In FIG. 5, after Network Device 115 (Node 1) and Network Device 135 (Node 3) build next hop list between each other, if any packet from address set {A, B, C} need to be sent to address set {x, Y, Z} need to go through network node 1 and 3, then fast routing method can be used when packet go through Network Device 115 and Network device 135.

In FIG. 5, when Network Device 115 receives a data packet where its destination address is in address set {X, Y, Z}, Network Device 115 can add fast routing header with pre-saved next hop list that can route data packet to Network Device 135 into the data packet and send the data packet to its next hop; when this data packet arrives Network Device 135, Network Device removes the fast routing header from the data packet and forwards the data packet to its next hop according its routing rule.

In FIG. 5, when Network Device 135 receives a data packet where its destination address is in address set {A, B, C}, Network Device 135 can add fast routing header with pre-saved next hop list that can route data packet to Network Device 115 into the data packet and send the data packet to its next hop; when this data packet arrives Network Device 115, Network Device removes the fast routing header from the data packet and forwards the data packet to its next hop according its routing rule.

For any network, fast routing method can also be used with other routing method together to increase the routing speed. It can work with MPLS: MPLS can be one element in next hop list, when a Network Device support fast routing method and MPLS is its current next hop, this Network Device can use MPLS rule to transfer data packet.

If the fast routing method can be used more close to the data packet source/data packet destination, the data packet can be transferred faster: all routing devices in the path that the data packet go through using fast routing method will use much less effort to routing the data.

When the data packet with fast routing header reach it last hop, the next hop list should be empty. The last node needs to check date from the higher layer and then decide how to handle the data packet. The last hop in next hop list is also can be mapped to an application: this is application to layer 2 directly mapping. In order to do this, when build the next hop list, the source node and/or destination node know that which application will use this routing next hop list; the source node and/or destination node put application ID into next hop list as last element of the next hop list of its destination node of this data packet.

For LAN switched network, there are three ways to add this next hop list in MAC layer protocol for LAN: A new Ethertype is defined and added in 802.3 standard; A new 802.1N tag to hold next hope list just like 802.1Q tag; Special multicast MAC address: indicates next 10 octets (mac source 6 octets and 802.1Q tag 4 octets) are next hop list information. In order to full power saving, the last physical port number in hop list can be mapped to one specific application that needs most data, this is application to layer 2 mapping. How and when to use this mothed: This tag is set between nodes-to-node who can support this new protocol; If node configuration changed, system need to rebuild next hop list; if session is short time period, there is no value to use this idea; Session with long time and big amount of data are best application of this idea.

How to add this next hop list: from source node, add a new tag in IP layer just like next hop in IP routing; instead of IP routing, it use next hop such as the physical port of the node that the data path goes through every node; when the ending node get the next hop list information, and need to send response message back: it send all information back to the source node through IP layer; When response message back, do same thing as above steps; So both side have next hop list through network and this list is a hash routing table. The new fast routing header will be added into data packet; When network node receives the data packet with a fast routing header, it get first hop in hop list which is next hop, remove it from hop list, forward the new packet to the next hop; When network node receives the data packet with a fast routing header, it get first hop in hop list which is next hop, remove it from hop list, forward the new packet to the next hop; All node just need to forward this data through this hop list and routing processing complex time is 0.

For LAN shared network, first is the node management. All nodes (PC/gateway/modem) under same shared physical media are controlled by the root gateways/routers that provide outside connection. The root gateways/routers manage all nodes under the shared physical media and mapping all nodes into visual physical port. Each node knows its mapped visual physical port and this port shall be used in next hop list. When packet received by a node, if first physical port number march its own visual physical port, then the node will treat this packet as its packet and do further data processing. Except this difference, everything else should be same as LAN switched network.

Fiber Channel layer 2 format as example. The components of the header, with all the optional items listed, are: SOF (1 word): The start of a frame; Frame Header (24 bytes): The header that specifies what protocol is being used, as well as the source and destination address. Varies depending on the protocol in question; Optional ESP Header (8 bytes): Provides encryption; includes the SPI and ESP sequence number; Optional Network Header (16 bytes). The 24 bytes of frame header, The FC frame format includes FC-specific information, including the source and destination, among others. The 24 bytes of frame header and 64 bytes optional Header can be used to carry next hop list.

Wan Network always switch network and the idea should be similar. Here take Generic Framing Procedures as example. A GFP frame consists of: A core header; A payload header; An optional extension header; A GFP payload; An optional payload frame check sequence (FCS). Core header, payload header, and optional extension header can work together to support fast routing header.

The above descriptions contained in each section are example designs.

Any of the devices (e.g., soft-switch servers, cellular network side equipment, IMS servers, Mobile devices, etc.) and components thereof, or software modules/programs described in this disclosure, can be realized by instructions that upon execution cause one or more processing devices to carry out the processes and functions described above. Such instructions can, for example, comprise interpreted instructions, such as script instructions, e.g., JavaScript or, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal can be an artificially generated signal, e.g., a machine generated electrical, optical, or electromagnetic signal that can be generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The elements of a computer typically include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile communications device, a telephone, a cable modem, a set-top box, a mobile audio or video player, or a game console, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be operable to interface with a computing device having a display, e.g., a CRT (cathode ray tube), LCD (liquid crystal display), LED (light emitting diode) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any invention or of what might be claimed, but rather as descriptions of features that might be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features might be described above as acting in certain combinations and even initially claimed as such, one or more features from a claimed combination can in some cases be excised from the combination, and the claimed combination might be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing might be advantageous

Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some designs, multitasking and parallel processing may be advantageous.

We claim:

1. A method comprising:
Building next hop lists among all network devices when data packets are transferred through these network devices;
Transferring next hop list information between all network devices
Storing the next hop list with destination set
Using the next hop list to transfer future data packet that its destination address belongs to the related destination set

2. The method of claim 1, wherein building next hop list comprises:
A network device identify its forward next hop according to its routing rule to the destination address of the data packet, add this forward next hop to Source Destination next hop list; a network device also identify its backward next hop according to its routing rule to the source address of the data packet, add this backward next hop to Destination Source next hop list;

3. The method of claim 1, wherein transferring next hop list comprises:
A network device forward all next hop list to Source and Destination with new header in IP layer or application layer.

4. The method of claim 1, wherein using next hop list comprises:
A source Network device that need to send a data packet, according to the destination of a data packet, comparing the destination of a data packet with the Destination Set, if matching, adding a fast routing header into data packet and putting the next hop list of the Destination Set into the fast routing header; for a network device that receiving a data packet with fast routing header, getting first element of the next hop list, using it to route the data packet; removing first element from the next hop list; sending data packet out to next hop.

5. The method of claim 4, a fast routing header comprising:
A header identifier defined to be used to carry a next hop list;
A next hop list to be used to route a data packet

6. The method of claim 4, a next hop list comprising:
One or more next hop to be used to route a data packet;
